(19) United States
(12) Patent Application Publication
(10) Pub. No.: US 2013/0318453 A1
(43) Pub. Date: Nov. 28, 2013

(54) APPARATUS AND METHOD FOR PRODUCING 3D GRAPHICAL USER INTERFACE

(71) Applicant: Samsung Electronics Co., Ltd., Gyeonggi-do (KR)

(72) Inventors: Moon-Sik JEONG, Gyeonggi-do (KR); Kumar Nipun, Gyeonggi-do (KR)

(73) Assignee: Samsung Electronics Co., Ltd., Gyeonggi-do (KR)

(21) Appl. No.: 13/901,156

(22) Filed: May 23, 2013

(30) Foreign Application Priority Data
May 23, 2012 (KR) 10-2012-0054742

(51) Int. Cl. G06F 3/0481

(52) U.S. Cl. CPC G06F 3/04815
USPC 715/763

(57) ABSTRACT

A 3D GUI producing method includes generating one or more 3D objects by using a 3D model according to a user's input and generating one or more animations by using the 3D objects; generating one or more main state nodes which indicate one state on the 3D GUI and can be changed to another state and one or more sub state nodes included in the main state node; adding an event, a sequence including a series of scenes corresponding to the event, and a target node to be transitioned to from the sub state node, to each of the sub state nodes; and generating the 3D GUI according to the event, sequence, and target node added to each of the sub state nodes.

### PRIORITY

This application claims priority under 35 U.S.C. §119(a) to Korean Application Serial No. 10-2012-0054742, which was filed in the Korean Intellectual Property Office on May 23, 2012, the entire content of which is incorporated herein by reference.

### BACKGROUND OF THE INVENTION

1. Field of the Invention

The present invention relates generally to a graphical user interface, and more particularly, to an apparatus and a method for producing a graphical user interface.

2. Description of the Related Art

A Graphical User Interface (GUI) refers to an operation environment where graphics show how and when a user exchanges information with an electronic device, such as a computer, a mobile terminal, a TV or the like. For example, a GUI may be an environment where, when the user desires to control a mobile terminal, the user can do so by selecting an icon displayed on the screen of the mobile terminal through a touch action, or an environment where, when the user desires to get information from a TV, the user can get the information by selecting a menu displayed on the TV screen through a remote control.

GUI technologies are being actively researched to introduce improved GUIs into various electronic devices as well as mobile devices such as mobile phones, smart phones, and the like, fueled by the current success of many products which have improved the user experience with such GUIs.

Particularly, as 3D graphical technologies have been developing, research on providing the technology to change from a flat 2D GUI to a 3D GUI has been actively progressing. A 3D GUI is stereoscopic and dynamic in comparison with a 2D GUI, which is flat and static, and a 3D GUI can provide a more visual and intuitive transmission of information. Due to these advantages, the GUI environments of many current digital devices are gradually changing from 2D to 3D. Particularly since 3D display devices, such as 3D TVs and the like, already provide 3D content, a user interface screen is also needed in 3D format.

A 3D GUI uses vision or a remote control based on gesture technology, such as interactive input. When creating a 3D GUI, the interactive input should be linked with 3D modeling or 3D contents, such as animation and the like. According to a current method of producing 3D GUIs, a designer creates 3D content with a 3D content producing tool, such as 3D modeling software, animation software, or the like, and then a UI programmer or developer does the programming that makes the interactive input possible using the 3D content, which results in the 3D GUI.

Accordingly, when a 3D GUI is being produced, designers must consider the interactive input which will be linked after the 3D content is produced. When the interactive input is later linked with the 3D content produced by the designers, the UI programmer has to ask the designers when the 3D content needs to be modified in any way, which makes 3D GUI production cumbersome and requires too many steps.

Further, according to the current method for producing a 3D GUI, when the programmer links the interactive input with the 3D content, the programmer cannot present a real time preview while the programming for the 3D GUI is still being generated. Accordingly, the designer cannot test an interactive version until the programmer completes all of the programming for the 3D GUI. Therefore, there is a need for a 3D GUI production apparatus which can quickly test a prototype 3D GUI.

In addition, currently there is no specialized program or tool for 3D GUI production, so there is a need for an apparatus for producing 3D GUIs which allows for the use of events based on interactive 3D content handling, has a simple interaction design producing framework, and provides an intuitive and standard GUI to the user.

### SUMMARY OF THE INVENTION

Accordingly, an aspect of the present invention is to provide an apparatus and a method for producing a 3D GUI, in which a 3D contents production and a 3D GUI production of linking an interactive input with the 3D contents are performed in one tool and an event based on interactive 3D contents handling and a simple interaction design producing framework can be used.

Further, another aspect of the present invention is to provide an apparatus and a method for producing a 3D GUI which can perform a real time preview for indentifying which 3D GUI is generated when an interactive input is linked with 3D contents.

In addition, still another aspect of the present invention is to provide an apparatus and a method for producing a 3D GUI, which can edit a 3D model itself of 3D contents and an animation using the 3D model instead of directly using the 3D contents produced in the outside and easily link an interactive input with the edited 3D contents. In accordance with an aspect of the present invention, a method of producing a 3D GUI is provided. The method includes generating one or more 3D objects by using a 3D model according to a user's input; generating one or more animations by using the 3D objects; generating one or more main state nodes which indicate one state on the 3D GUI and can be changed to another state, and one or more sub state nodes included in the main state node; adding an event, a sequence including a series of scenes corresponding to the event, and a target node to be transitioned to from the sub state node, to each of the one or more sub state nodes; and generating the 3D GUI according to the event, sequence, and target node added to each of the one or more sub state nodes.

In accordance with another aspect of the present invention, an apparatus for producing a 3D GUI is provided. The apparatus includes a user interface unit which receives an input from a user and displays a processing result; a resource importer which loads a 3D model and a resource required for producing the 3D GUI; an animation engine which generates 3D objects by using the 3D model and generates one or more animations by using the 3D objects; a state machine engine which generates main state nodes which indicate one state on the 3D GUI and can be changed to another state and one or more sub state nodes according to a user's input; a scene abstraction module which adds an event, a sequence including a series of scenes corresponding to the event, and a target node to be transitioned to from the sub state node, to each of the one or more sub state nodes according to the user's input and generates the 3D GUI according to the event, sequence, and target node added to each of the one or more sub state nodes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features, and advantages of the present invention will be more apparent from the following detailed description taken in conjunction with the accompanying drawings, in which:

FIG. 1 illustrates a configuration of a 3D GUI producing apparatus according to an embodiment of the present invention;

FIG. 2 is a flowchart illustrating a 3D GUI producing method according to an embodiment of the present invention;

FIG. 3 illustrates an example of a 3D GUI producing screen displayed on a 3D GUI producing apparatus according to an embodiment of the present invention;

FIG. 4 illustrates a sub menu for loading a 3D model according to an embodiment of the present invention;

FIG. 5 illustrates an example of a screen which changes a viewing angle of a 3D model according to an embodiment of the present invention;

FIG. 6 illustrates an example of a screen which changes a rotation of a 3D model according to an embodiment of the present invention;

FIG. 7 illustrates an example of a screen which changes a movement and scale of a 3D model according to an embodiment of the present invention;

FIG. 8 illustrates an example of animation generation using a 3D object according to an embodiment of the present invention;

FIG. 9 illustrates an example of a state node generating screen according to an embodiment of the present invention;

FIG. 10 illustrates an example of a screen which allocates an event, a sequence, and a target node to sub state nodes according to an embodiment of the present invention;

FIG. 11 illustrates an event generator according to an embodiment of the present invention;

FIG. 12 illustrates an example of an event according to an embodiment of the present invention;

FIG. 13 illustrates a sequence generator according to an embodiment of the present invention;

FIG. 14 illustrates an example of main state nodes and sub state nodes of a generated 3D GUI according to an embodiment of the present invention; and

FIGS. 15A to 15C illustrate examples of a screen which displays a generated 3D GUI according to an embodiment of the present invention.

### DETAILED DESCRIPTION OF EMBODIMENTS OF THE PRESENT INVENTION

Hereinafter, various embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

Embodiments of the present invention disclose an apparatus and a method for producing a 3D Graphical User Interface (GUI) which can be applied to various electronic devices, such as TVs and the like, as well as mobile devices, such as mobile phones, smart phones, and the like.

Particularly, according to embodiments of the present invention, a target display environment is selected by a user (developer or designer) and a 3D GUI according to the set target display environment is produced. The target display environment may vary depending on the display screen size(s), screen resolution(s), and whether 3D imaging is supported by the target electronic device(s). Once the target display environment is set, the 3D GUI producing apparatus according to an embodiment of the present invention produces 3D content either by loading an already existing 3D model or by modifying and editing or directly using a 3D model prepared within the apparatus, to generate one or more animations. Further, the apparatus for producing a 3D GUI according to an embodiment of the present invention produces a 3D GUI by generating a sequence including a series of one or more scenes among scenes generated through reproducing one or more animations of 3D content and linking the sequence with one or more interactive capabilities. Specifically, the 3D GUI producing apparatus according to an embodiment of the present invention produces a 3D GUI by generating nodes corresponding to states on the 3D GUI according to a user selection, adding one or more interaction events required for user interaction to the nodes, and allocating a sequence and a target node to each event.

According to the apparatus and the method for producing a 3D GUI according to the embodiment of the present invention, 3D GUI production can be conveniently and easily performed as the user modifies and edits the 3D content and links the interaction input with the 3D content using the same tool.

The 3D GUI produced as described above may be applied to various electronic devices, such as TVs and the like, as well as mobile devices, such as smart phones and the like, to enable interaction between the user and those various electronic devices.

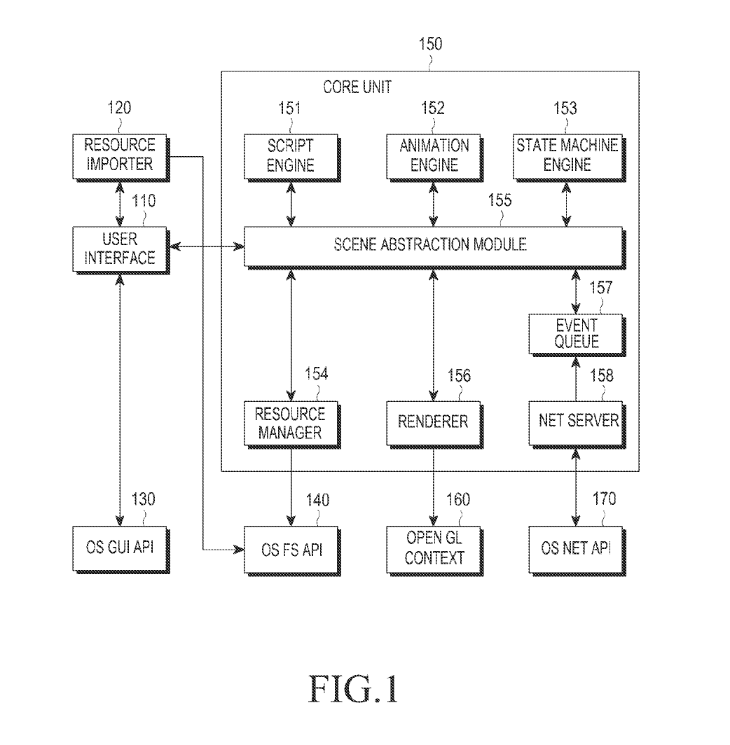

Hereinafter, a configuration of the 3D GUI producing apparatus according to an embodiment of the present invention will be described. FIG. 1 illustrates the configuration of the apparatus for producing a 3D GUI according to an embodiment of the present invention.

Referring to FIG. 1, the 3D GUI producing apparatus includes user interface 110, resource importer 120, Operating System Graphic User Interface Application Program Interface (OS GUI API) 130, Operating System File System Application Program Interface (OS FS API) 140, core unit 150, Open Graphics Library (OpenGL) context 160, and Operating System net Application Program Interface (OS net API) 170.

The user interface 110 may include an input unit for receiving various inputs from the user, such as a keyboard, a keypad, a touch pad, a mouse or the like and a display unit for outputting various input processing results to the user. The user interface 110 enables interaction between the user and the 3D GUI producing apparatus.

When a resource is required according to an input of the user through the user interface 110, the resource importer 120 loads required resources using a library provided by the OS FS API 140. For example, the resource importer 120 may load a 3D model required for producing the 3D GUI from an external or internal storage unit and can load any other required resources.

The OS GUI API 130 enables access to and use of the GUI supported by the OS according to an input of the user through the user interface 110 and provides a library required for OS GUI application programming.

The OS FS API 140 enables access to and use of an OS file system and provides a library required for OS file system application programming.

The core unit 150 includes a script engine 151, an animation engine 152, a state machine engine 153, a resource manager 154, a scene abstraction module 155, a renderer 156, an event queue 157, and a net server 158.

The script engine 151 loads and executes predetermined script files required for generating 3D objects by using a 3D model.

The animation engine 152 includes an animator for generating an animation and a sequence generator for generating and reproducing a sequence including a series of consecutive scenes of the animation, and generates one or more animations according to an input of a motion of the 3D object by the user by using a time line and key-frames.

The state machine engine 153 generates at least one main state node corresponding to a transition position which indicates one state (for example, menu) on the 3D GUI and can be changed into another state according to a user's input. Further, the state machine engine 153 generates at least one sub state node to which an event, a sequence including a series of scenes corresponding to the event, and a target node corresponding to the event, are allocated in each of the state nodes according to a user's input.

The resource manager 154 edits a texture, material and the like of the 3D model, changes a viewing angle, zoom, and camera angle, or selects a movement, rotation, flip, mirror, scale and the like of the 3D model by using the OS FS API 140 to provide resources required for generating one or more 3D objects.

The scene abstraction module 155 controls general operations of the core unit 150 and sets a 3D GUI target display environment according to a user's request through the user interface 110. In other words, the display format and the display screen size of the device to which the 3D GUI will be applied are set according to a user's request through the user interface 110. Further, when the 3D model is provided through the resource importer 120, the scene abstraction module 155 edits the texture, material and the like of the 3D model, changes the viewing angle, zoom, camera angle, or selects the movement, rotation, flip, mirror, scale and the like of the 3D model by using a script and a library provided by the script engine 151 and the resource manager 154 according to user input in the set display environment so as to generate one or more 3D objects. A 3D object may be generated by grouping one or more objects. The scene abstraction module 155 previews the generated 3D objects on a viewport of the display unit by using the renderer 156.

Further, when a motion is added to one or more 3D objects according to an input by the user, the scene abstraction module 155 generates an animation by using the animation engine 152. For example, the scene abstraction module 155 can generate an animation by reflecting a rotation, a revolution, a travel path, an orbit, a cascading, a stepping, a spiral, a pop up effect, a position change from an initial position to a last position, a movement, a speed, a tempo, an acceleration, a direction, a physical property and the like to any of the 3D objects by using the time line and key-frames according to the motions of the one or more 3D objects.

Further, the scene abstraction module 155 sets a scene selected by the user among scenes of the animation as a scene corresponding to the main state node generated by using the state machine engine 153. In addition, the scene abstraction module 155 adds an event generated by the user to the sub state node of a state node and allocates the sequence including a series of scenes and the target node corresponding to the event to each sub state node to produce the 3D GUI.

The renderer 156 renders the 3D object, the scene of the 3D object, or the generated 3D GUI to display the rendered 3D object, scene, or 3D GUI on a display unit screen of the user interface 110. The renderer 156 may be an Open GL render, and can perform the rendering by using the Open GL context 160. The Open GL context 160 corresponds to a 2D and 3D graphics API standard, which is a context for supporting cross application programming between a programming language and a platform.

The event queue 157 collects asynchronous events generated and input by the user and sequentially provides the collected events. The net server 158 receives and processes network packets by using the OS NET API 170. The OS NET API 170 allows access to and use of the OS NET, and provides any library required for application programming using the OS NET.

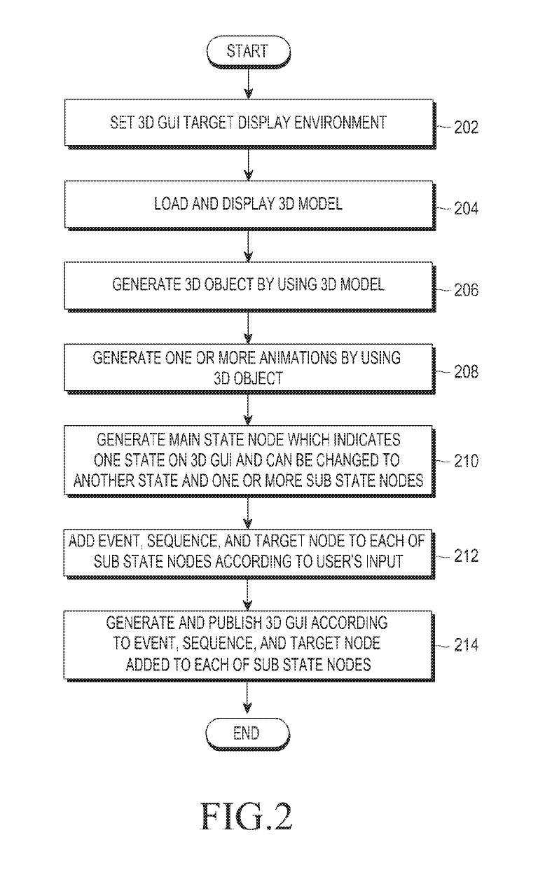

Hereinafter, an operation of the 3D GUI producing apparatus configured as described above according to the embodiment of the present invention will be described in detail. FIG. 2 is a flowchart illustrating a 3D GUI producing method according to an embodiment of the present invention.

Referring to FIG. 2, the 3D GUI producing apparatus sets a 3D GUI target display environment according to a user's request through the user interface unit 110 in step 202. For example, the display format and display screen size of the device to which the 3D GUI will be applied may be set in step 202.

Further, the 3D GUI producing apparatus loads a 3D model through the resource importer 120 according to a user's request and displays the 3D model on the display unit of the user interface unit 110. The 3D model may be pre-stored in the 3D GUI producing apparatus or loaded from an external memory, and is displayed on the 3D GUI producing screen using the display unit of the user interface 110.

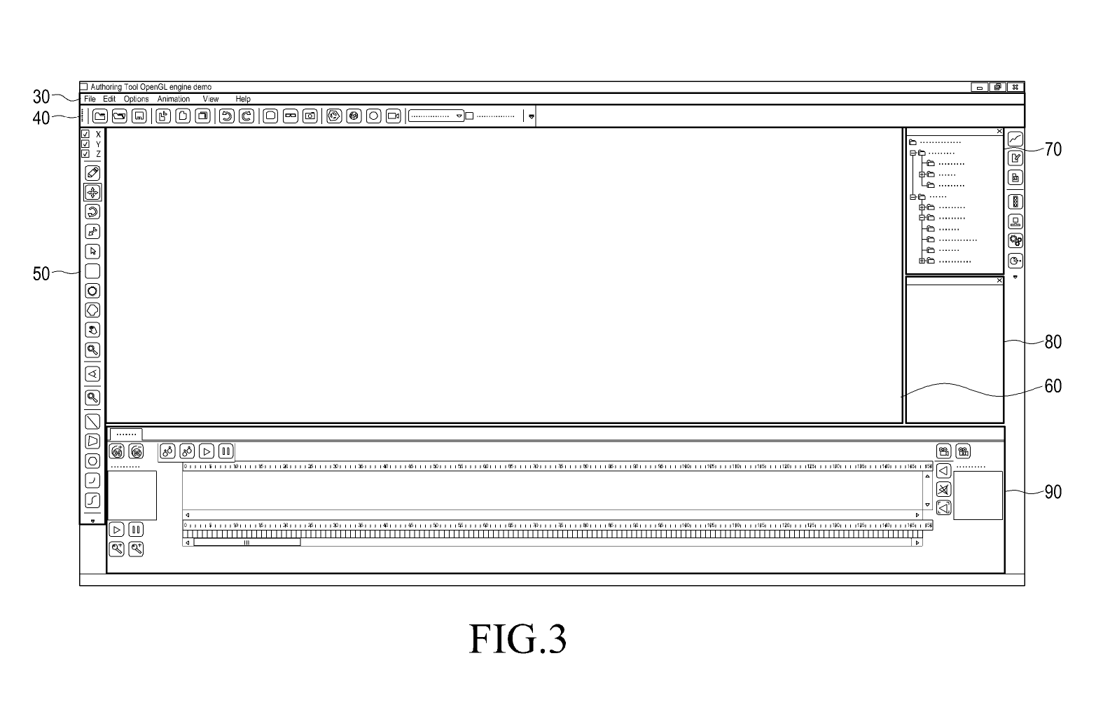

FIG. 3 illustrates an example of the 3D GUI producing screen displayed by the 3D GUI producing apparatus according to an embodiment of the present invention. Referring to FIG. 3, the 3D GUI producing screen includes a main menu bar area 30, a main tool bar area 40, a secondary tool bar area 50, a viewport area 60, an object area 70, a property area 80, and an animation area 90.

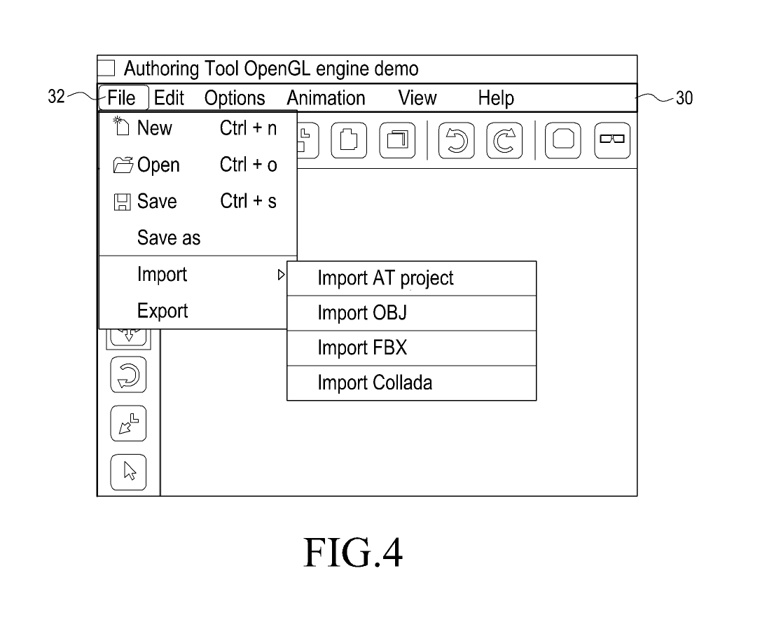

FIG. 4 shows an example where the user selects a file menu 32 from the main menu bar area 30 of the 3D GUI producing screen in FIG. 3 to make a request for loading a 3D model. FIG. 4 illustrates a sub menu for loading a 3D model according to an embodiment of the present invention. Referring to FIG. 4, the 3D GUI producing apparatus displays sub menus corresponding to the file menu 32 as the user selects the file menu 32 from the main menu bar area 30. When the user selects an “import” menu among the sub menus, the 3D GUI producing apparatus loads a pre-stored 3D model or a 3D model stored in an external memory according to the type of “import” selected by the user, and displays the loaded 3D model in the viewport area 60.

Further, the 3D GUI producing apparatus edits a texture, material and the like of the 3D model according to user input; changes a viewing angle, zoom, or camera angle according to user input; or changes a movement, rotation, flip, mirror, scale or the like of the 3D model according to user input in order to generate one or more 3D objects in step 206 of FIG. 2.

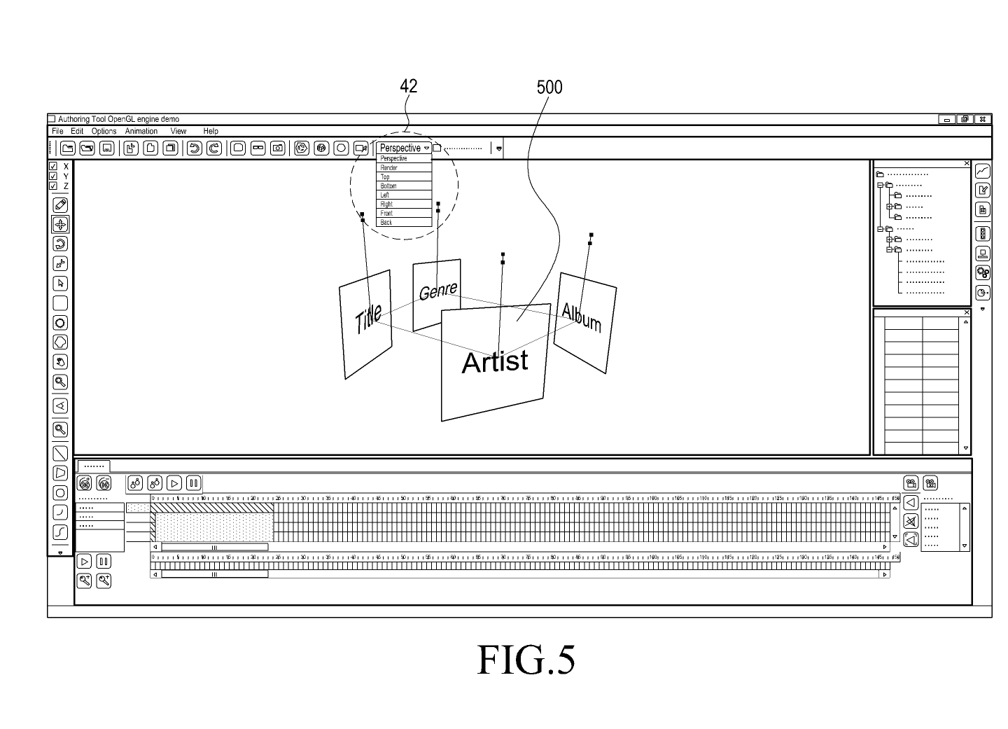

FIG. 5 illustrates an example of a screen which changes the viewing angle of the 3D model according to an embodiment of the present invention. Referring to FIG. 5, the user of the 3D GUI producing apparatus can change the viewing angle of 3D model 500 displayed in the viewport area 60 by selecting viewing angle menu 42 of main tool bar area 40.

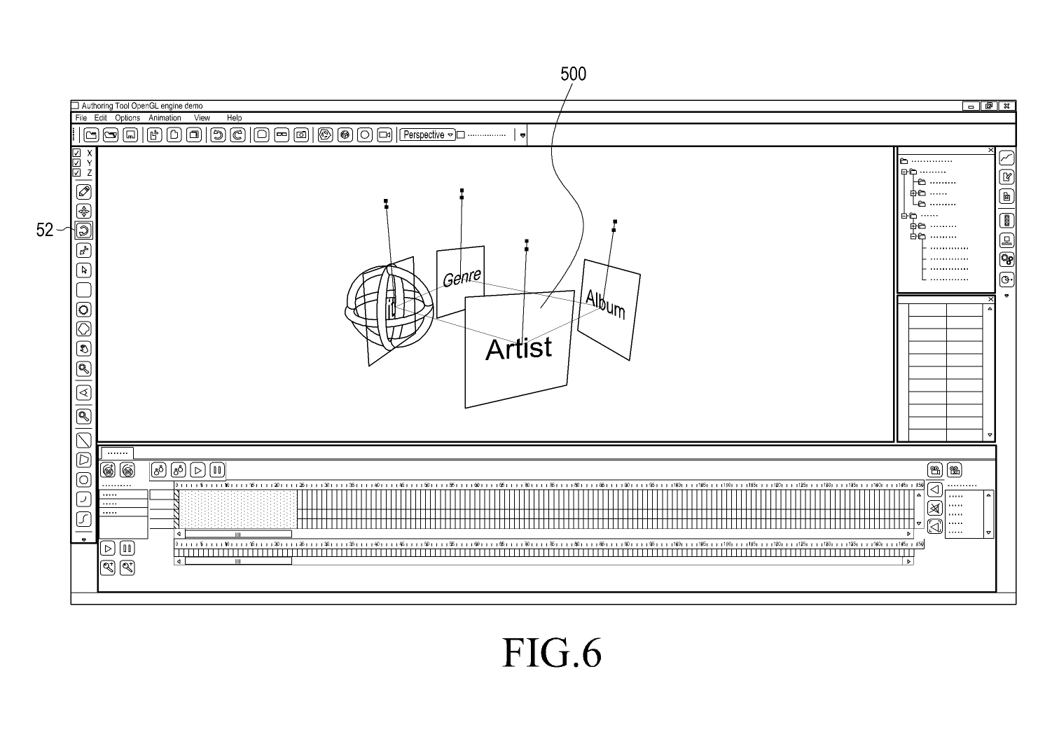

Further, FIG. 6 illustrates an example of a screen which changes the rotation of the 3D model according to an embodiment of the present invention. Referring to FIG. 6, the user of the 3D GUI producing apparatus can change the rotation of 3D model 500 displayed in the viewport area 60 by selecting rotation menu 52 of secondary tool bar area 50.

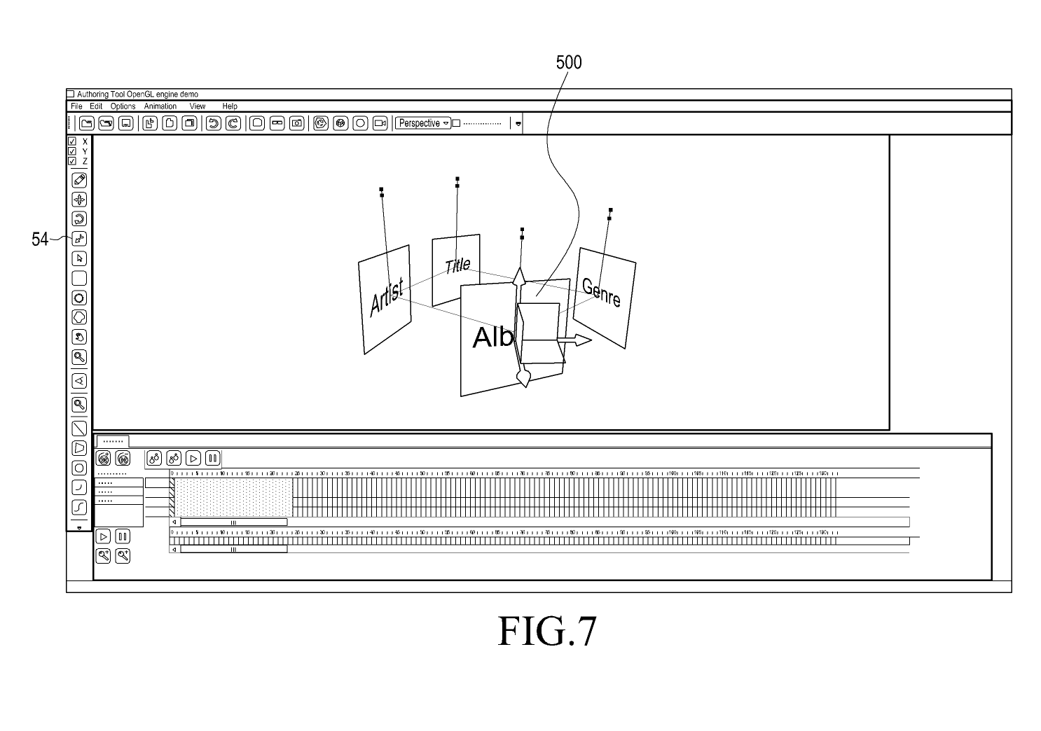

Further, FIG. 7 illustrates an example of a screen which changes the movement and scale of the 3D model according to an embodiment of the present invention. Referring to FIG. 7, the user of the 3D GUI producing apparatus can change the movement and scale of 3D model 500 displayed in the viewport area 60 by selecting movement and scale menu 54 of secondary tool bar area 50.

When a 3D object is generated as the user edits and changes the 3D model 500 as described above, the 3D GUI producing apparatus proceeds to step 208 in FIG. 2 and generates one or more animations by using the 3D object. When a motion is added to one or more 3D objects according to a user's input, the 3D GUI producing apparatus generates an animation by using the animation engine 152.

That is, the 3D GUI producing apparatus generates an animation by reflecting a rotation, a revolution, a travel path, an orbit, a cascading, a stepping, a spiral, a pop up effect, a position change from an initial position to a last position, a movement, a speed, a tempo, an acceleration, a direction, a physical property and the like in any of the 3D objects by using the time line and key-frames according to the motions of the one or more 3D objects.

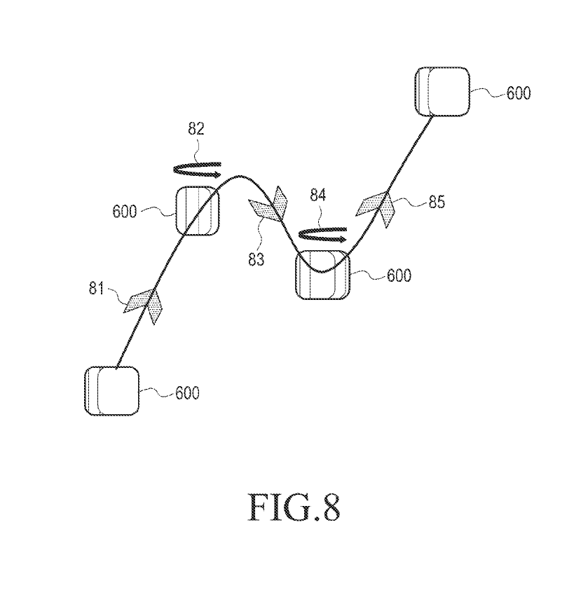

FIG. 8 illustrates an example of animation generation using a 3D object according to an embodiment of the present invention. Referring to FIG. 8, when the user moves 3D object 600 along traveling path 81, rotates the 3D object in a counterclockwise direction 82, moves 3D object 600 along traveling path 83, rotates 3D object 600 in a counterclockwise direction 84, and then moves 3D object 600 along traveling path 85, the 3D GUI producing apparatus generates an animation having the corresponding traveling path and rotation.

Further, on the animation, the 3D GUI producing apparatus generates a main state node corresponding to a transition position which indicates one state (for example, a menu) on the 3D GUI of the animation and can be changed into another state and at least one of sub state nodes of the main state node according to a user's input in step 210 of FIG. 2.

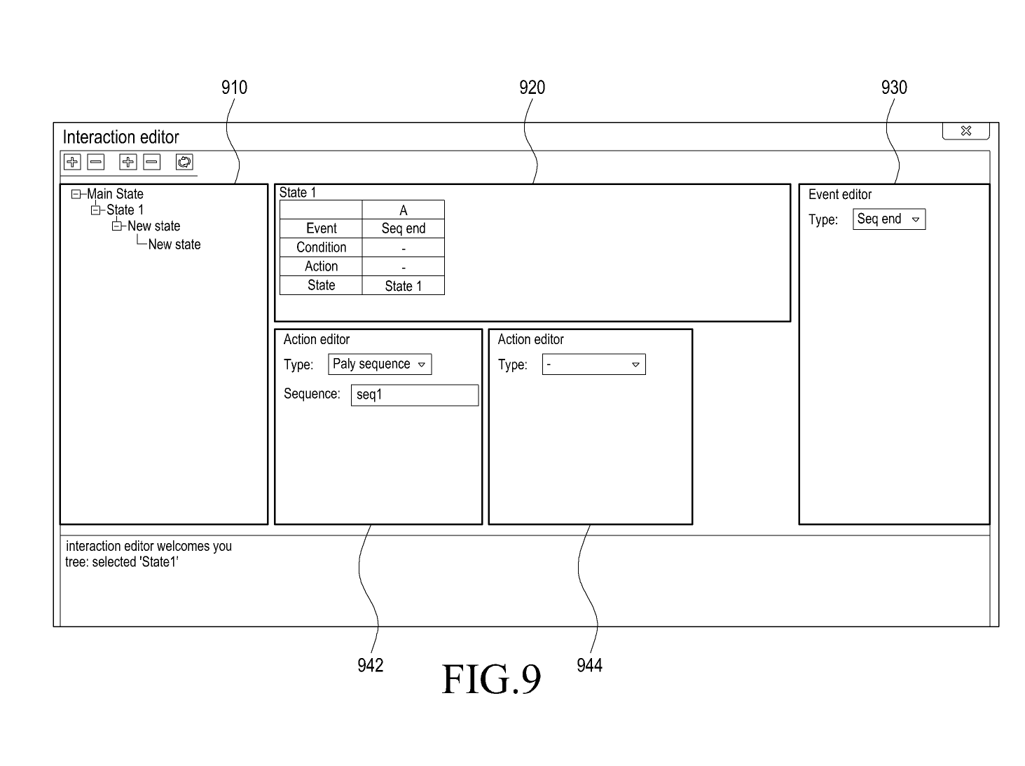

FIG. 9 illustrates an example of a state node generating screen according to an embodiment of the present invention. Referring to FIG. 9, the state node generating screen includes state node generating area 910, state node transition table area 920, event editor area 930, and first and second action editor areas 942 and 944. The state node generating area 910 is an area in which the user can generate a main state node and any sub state nodes of the main state node according to the user's input. The state node transition table area 920 is an area in which the user can set a state name, event, condition, and action for each of the state nodes according to the user's input. The event editor area 930 is an area in which the user sets an event for the state node. The first and second action editor areas 942 and 944 are areas in which the user can set an action entering a current state and an action ending the current state according to the user's input, respectively. The user can generate the main state node and at least one of the sub state nodes of the main state node through the state node generating screen.

The 3D GUI producing apparatus adds an event, a sequence including a series of scenes corresponding to the event, and a target node corresponding to the event to each sub state node according to a user's input in step 212 of FIG. 2.

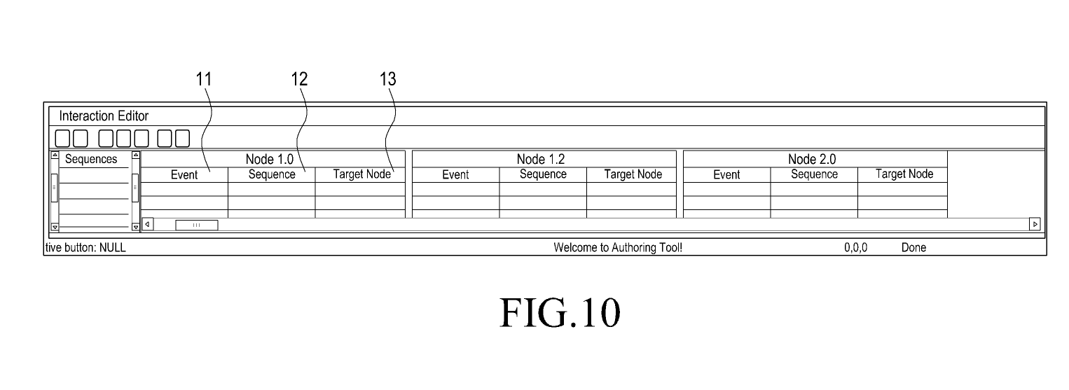

For FIG. 10 illustrates an example of a screen by which the user allocates an event, a sequence, and a target node to a sub state node according to an embodiment of the present invention. Referring to FIG. 10, the event, the sequence, and the target node can be added to each of the pre-generated sub nodes by using event area 11, sequence area 12, and target node area 13.

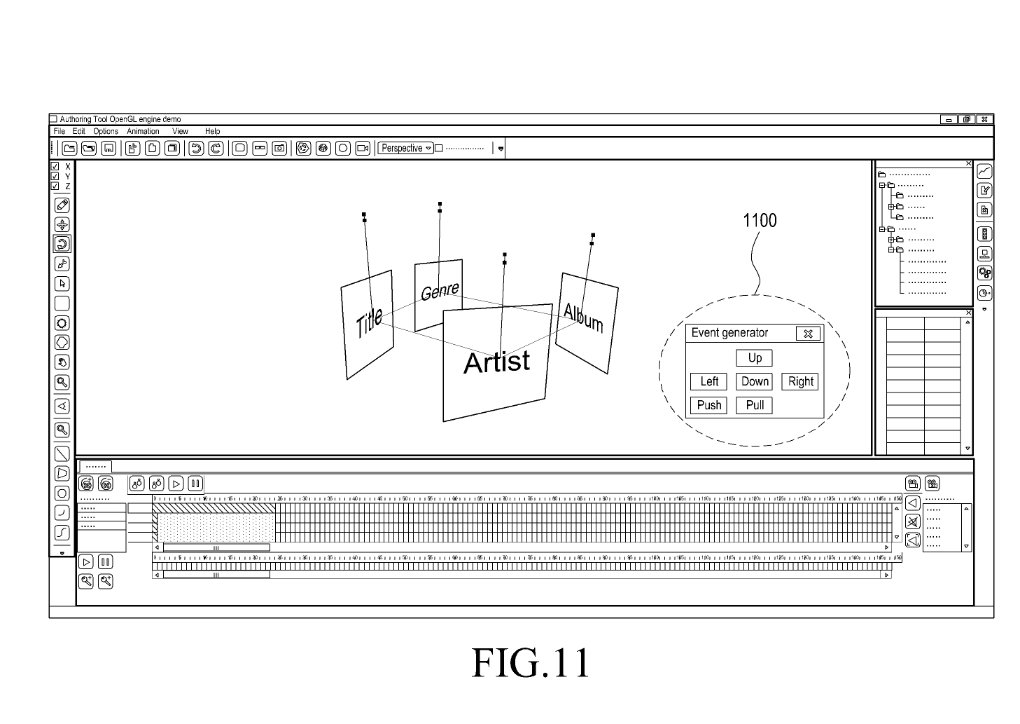

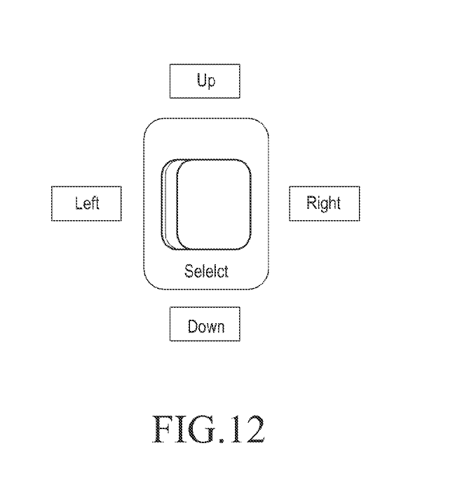

An event may be generated by the event generator and then added. For example, FIG. 11 illustrates an event generator according to an embodiment of the present invention. Referring to FIG. 11, the user can generate a desired event by using an event generator 1100. FIG. 12 illustrates an example of events according to an embodiment of the present invention. Referring to FIG. 12, five events (up, down, left, right, and select) are generated. These events refer to an input event where the user has provided directional input by, for example, selecting, pressing, or touching an input device, such as a touchscreen. The number, names, and designs of the events can be changed.

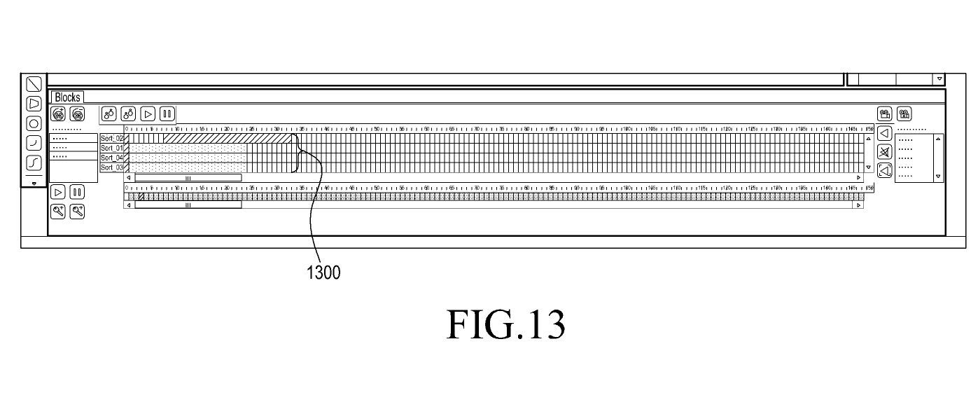

A sequence may be generated by the sequence generator and then added. For example, FIG. 13 illustrates a sequence generator according to an embodiment of the present invention. Referring to FIG. 13, the sequence generator includes time lines 1300 indicating reproduction of one or more animations. The user generates a sequence, including a series of scenes, by selecting reproduction sections of the one or more animations, and then putting the reproduction sections in sequence by using the time lines.

The target node is the destination state node transitioned to from the current state node, and may be selected from pre-generated state nodes and then added.

In step 214 of FIG. 2, the 3D GUI producing apparatus generates and publishes the 3D GUI according to the event, the sequence including a series of scenes corresponding to the event, and the target node corresponding to the event, which were added to each of the sub state nodes in step 212.

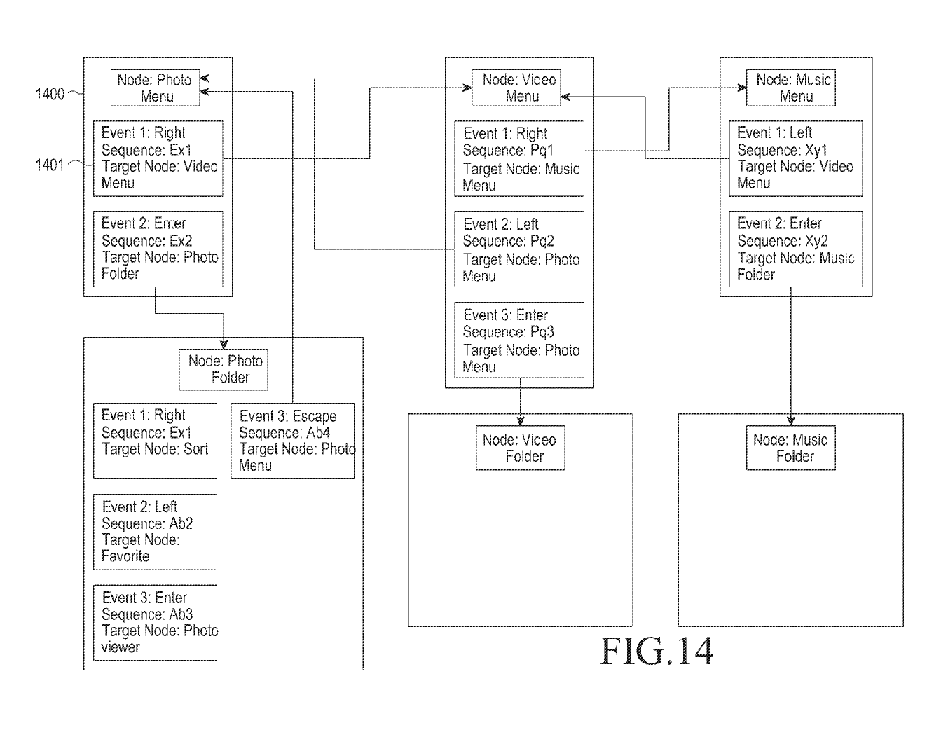

FIG. 14 illustrates an example of main state nodes and sub state nodes of a generated 3D GUI according to an embodiment of the present invention. Referring to FIG. 14, a main state node may correspond to a photo menu, a video menu, a music menu, a photo folder, a video folder, a music folder or the like, and each of the Photo Menu Node, the Video Menu Node, the Music Menu Node, the Photo Folder Node, the Video Folder Node, and the Music Folder Node includes one or more sub state nodes. An event, a sequence, and a target node can be added to each of the sub state nodes. When an event corresponding to the sub state node is input to the main state node, the sequence corresponding to the event is reproduced, and then a transition to the target node is made. For example, when a Right event is input to Photo Menu Node 1400 by the user, Sequence Ex1 is reproduced according to sub state node 1401, which corresponds to the Right event, and a transition to the main state node corresponding to the video menu is made.

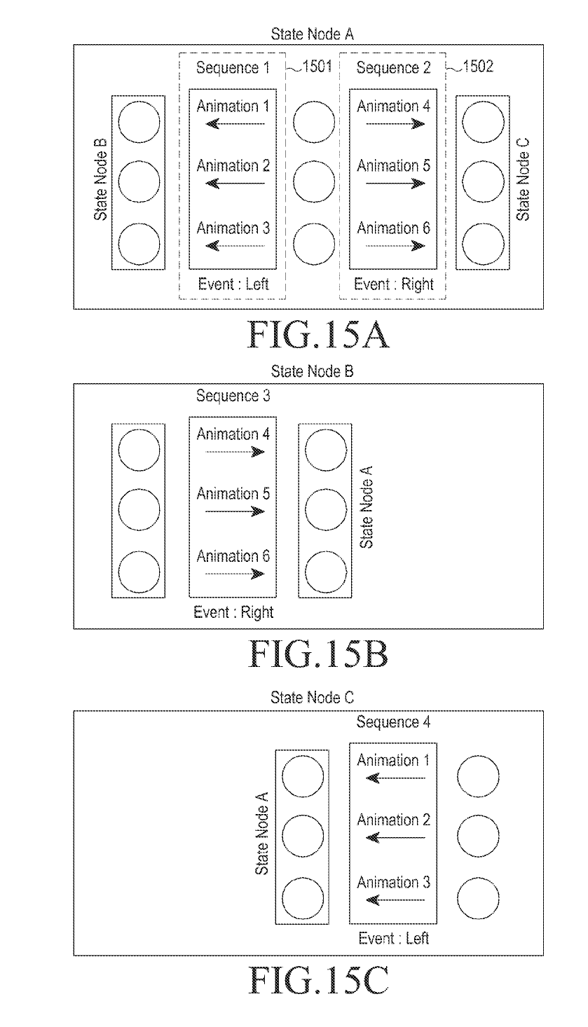

FIGS. 15A to 15C illustrate examples where a generated 3D GUI is displayed on the screen according to an embodiment of the present invention. Referring to FIG. 15, a 3D GUI having three main state nodes, State Node A, State Node B, and State Node C, is illustrated. FIG. 15A is the screen of State Node A. FIG. 15B is the screen of State Node B. FIG. 15C is the screen of State Node C.

Referring to FIG. 15A first, State Node A includes first sub state node 1501 and second sub state node 1502. Further, first sub state node 1501, which corresponds to a Left event, is allocated Sequence 1, which includes a series of scenes corresponding to reproduction sections Animation 1, Animation 2, and Animation 3 as its sequence, and is allocated State Node B as its target node. Second sub state node 1502, which corresponds to a Right event, is allocated Sequence 2, which includes a series of scenes corresponding to reproduction sections Animation 4, Animation 5, and Animation 6 as its sequence, and is allocated State Node C as its target node.

When a Left event is input by the user while in State Node A, as shown in FIG. 15A, Sequence 1 is reproduced, and then a transition to the screen of State Node B is made (which screen behaves as shown in FIG. 15B). When a Right event is input by the user, Sequence 2 is reproduced, and then a transition to the screen of State Node C is made (which screen behaves as shown in FIG. 15C).

According to an embodiment of the present invention, the user can change and edit 3D content and conveniently and easily link interaction input with the 3D content with the same tool in order to produce a 3D GUI. Further, the user can preview the 3D GUI while it is being generated in real time and thus quickly test a prototype 3D GUI while the 3D GUI is being produced.

While the present invention has been shown and described with reference to certain embodiments thereof, it will be understood by those skilled in the art that various changes in form and details may be made therein without departing from the spirit and scope of the present invention as defined by the appended claims. For example, according to embodiments of the present invention, although the state node has been described through a particular menu as an example, and the event has been described through a particular event as an example, the present invention is not limited thereto. Therefore, the scope of the present invention should not be defined by the embodiments of the present invention, but should be defined by equivalents to the claims.

What is claimed is:

1. A method of producing a three-dimensional (3D) graphical user interface (GUI), the method comprising:
generating one or more 3D objects by using a 3D model according to a user's input;
generating one or more animations using the 3D objects;
generating one or more main state nodes which indicate one state on the 3D GUI and can be changed to another state and one or more sub state nodes included in the main state node;
adding an event, a sequence including a series of scenes corresponding to the event, and a target node to be transitioned to from the sub state node, to each of the one or more sub state nodes; and
generating the 3D GUI according to the event, sequence, and target node added to each of the one or more sub state nodes.

2. The method of claim 1, further comprising generating an input event by which a user of the 3D GUI can select, press, or touch, according to the 3D GUI production method user's input.

3. The method of claim 1, further comprising generating a series of scenes corresponding to one or more reproduction sections selected by the user among reproduction sections of the one or more animations as the sequence.

4. The method of claim 1, further comprising displaying the generated 3D GUI.

5. An apparatus for producing a three-dimensional (3D) graphical user interface (GUI), the apparatus comprising:
a user interface unit which receives input from a user and displays a processing result;
a resource importer which loads a 3D model and a resource required for producing the 3D GUI;
an animation engine which generates 3D objects by using the 3D model and generates one or more animations by using the 3D objects;
a state machine engine which generates main state nodes which indicate one state on the 3D GUI and can be changed to another state and one or more sub state nodes according to the user's input;
a scene abstraction module which adds an event, a sequence including a series of scenes corresponding to the event, and a target node to be transitioned to from the sub state node, to each of the one or more sub state nodes according to the user's input and generates the 3D GUI according to the event, sequence, and target node added to each of the one or more sub state nodes.

6. The apparatus of claim 5, further comprising an event generator which generates an input event by which a user of the 3D GUI can select, press, or touch, according to the 3D GUI production apparatus user's input.

7. The apparatus of claim 5, wherein the scene abstraction module generates a series of scenes corresponding to one or more reproduction sections selected by the user among reproduction sections of the one or more animations as the sequence.

8. The apparatus of claim 5, further comprising a renderer which renders the generated 3D GUI.
